(19) United States
(12) Patent Application Publication
(10) Pub. No.: US 2024/0319765 A1
(43) Pub. Date: Sep. 26, 2024

(54) ENCLOSURE WITH CUSTOMIZED MEDIA DISPLAY

(71) Applicant: M Cacao, Amesbury, MA (US)

(72) Inventor: Michael Nichols, Amesbury, MA (US)

(21) Appl. No.: 18/599,707

(22) Filed: Mar. 8, 2024

Related U.S. Application Data
(60) Provisional application No. 63/453,184, filed on Mar. 20, 2023.

(51) Int. Cl. G06F 1/16; B65D 51/24

(52) U.S. Cl. CPC G06F 1/1605; B65D 51/24; G06F 1/1626; G06F 1/1677

(57) ABSTRACT

A customizable enclosure is configured to output media via an interface. A sender may select one or more media files for output by the customizable enclosure once received by a recipient. The enclosure may be configured to output one or more media files on opening and/or when an item is removed from the enclosure.

### PRIORITY CLAIM

This application claims priority to U.S. Provisional Patent Application No. 63/453,184, filed Mar. 20, 2023, the entire contents of which are incorporated by reference herein.

### FIELD

The present disclosure relates generally to an enclosure and, more particularly, to a customizable enclosure with a media display screen.

### BACKGROUND

Conventional systems fail to adequately customize enclosures or personalize the experience for a recipient.

### SUMMARY

All aspects, examples and features mentioned below can be combined in any technically possible way.

An aspect of the disclosure provides an enclosure, including: a base including a set of storage cavities; a moveable lid coupled with the base for enclosing the set of storage cavities; memory configured to store at least one media file; a display screen electrically coupled with the memory and disposed on an inner surface of the moveable lid; and a controller coupled to the display screen. The controller is configured to control display of the at least one media file on the display screen.

Another aspect of the disclosure includes any of the preceding aspects, and an enclosure including: a set of sensors each corresponding with the set of storage cavities and coupled with the controller. Each sensor being configured to transmit an electrical signal to the controller to display at least one of the media files. Each sensor may further include at least one of an infrared sensor, a pressure sensor, an electromagnetic sensor, or a motion sensor.

Another aspect of the disclosure includes any of the preceding aspects, and an enclosure including a lid sensor coupled with the controller for signaling that the movable lid is at least one of opened or closed. The lid sensor may include a sensor system having a first magnet coupled with the base, and a magnetic sensor coupled with the moveable lid and the controller. The magnetic sensor is configured to transmit an electrical signal to the controller when the magnetic sensor is not in proximity to the first magnet. The controller may be configured to initiate playback on the display screen in response to receiving the electrical signal from the magnetic sensor. In some embodiments, the sensor system may further include a second magnet coupled with the moveable lid, the second magnet being configured to clasp with the first magnet in the sidewall in a closed position of the enclosure. In such embodiments, the magnetic sensor may be further configured to transmit an electric signal in response to magnetic coupling or magnetic decoupling between the first and second magnets.

Another aspect of the disclosure includes any of the preceding aspects, and an enclosure including: a set of storage cavities that are defined by an insert configured to receive one or more items therein. The one or more items may include at least one of confectionaries, cosmetic items, food items, gift items, wearable items, or symbols. For example, the one or more items disposed within the enclosure may include at least one of chocolates, candy, jewelry, perfume, sunglasses, cosmetic application devices, etc. Although the enclosure embodiments according to the disclosure are primarily described as a “box of chocolates,” the disclosure is not limited to chocolate and may be useful to contain any physical good.

Another aspect of the disclosure includes any of the preceding aspects, and an enclosure including: an interface coupled with a controller and configured to control display of one or more media files. The interface may include, for example, one or more of a play button, a pause button, a skip forward button, a skip backward button, or a volume control button. The interface may further include a touch-screen interface, haptic feedback, or a combination thereof.

Another aspect of the disclosure includes any of the preceding aspects, and an enclosure including a battery coupled with the controller.

Another aspect of the disclosure includes any of the preceding aspects, and an enclosure including an input port configured for uploading and/or downloading the at least one media file to the memory.

Another aspect of the disclosure includes any of the preceding aspects, and an enclosure including a moveable lid that is removably coupled to the base.

Another aspect of the disclosure includes any of the preceding aspects, and an enclosure including a speaker configured to play an audio file of the one or more media files. Another aspect of the disclosure includes any of the preceding aspects, and a system including an enclosure, and an external processor that is configured to: receive at least one initial media file; compare a format of the at least one initial media file with a playback requirement of the controller; and if the format of the at least one initial media file does not comply with the playback requirement of the controller, reformat one or more initial media files to provide the at least one media file in a compliant format. In some embodiments, the reformatting includes at least one of compressing the one or more initial media files, transcoding the at least one initial media file, adjusting a resolution and aspect ratio of the at least one initial media file, or distorting a portion of the at least one initial media file. The external processor may be further configured to transfer the at least one media file in the compliant format to the enclosure.

Another aspect of the disclosure includes any of the preceding aspects, and an enclosure including a set of storage cavities that includes a plurality of storage cavities with an associated sensor. The controller is configured to output a distinct portion of the at least one media file based on receiving an input from a distinct sensor in a distinct storage cavity. In some embodiments, the at least one media file includes a plurality of distinct media files each associated with one or more of the plurality of storage cavities. In other embodiments, each of the plurality of storage cavities is configured to store a distinct item, and in response to removal of an item from a storage cavity as detected by an associated sensor, the controller is configured to output a select one of the distinct media files.

Another aspect of the disclosure includes any of the preceding aspects, and a method, including: receiving an indicator that an enclosure having a display screen on an inner surface thereof is open; and displaying a media file on the display screen of the enclosure in response to detecting opening of the enclosure.

Another aspect of the disclosure includes any of the preceding aspects, and a method, including loading the media file onto a memory at the enclosure. In some embodiments, the method further includes reformatting an initial media file to provide the media file prior to loading the media file onto the memory.

Another aspect of the disclosure includes any of the preceding aspects, and a method, including providing a graphical user interface (GUI) enabling selection of the media file for upload and items to store in the enclosure. In some embodiments, the method further includes receiving a selection of the media file and a selection of the items to store in the enclosure via the GUI; and preparing the enclosure for delivery to a recipient.

Another aspect of the disclosure includes any of the preceding aspects, and a method, including: providing a graphical user interface (GUI) for selection of storage items in an enclosure; prompting a user to send a media file for playback at the enclosure via the GUI; transferring the media file to memory at the enclosure; and preparing the enclosure for delivery to a recipient.

Another aspect of the disclosure includes any of the preceding aspects, and a method including reformatting the media file prior to transferring the media file to memory at the enclosure.

Another aspect of the disclosure includes any of the preceding aspects, and a method including parsing the media file to associate segments of the media file with distinct cavities in the enclosure.

Another aspect of the disclosure includes any of the preceding aspects, and an external processor (e.g., a server) configured to receive one or more media files from a user via a GUI, and process the one or more media files prior to uploading the processed media files to an enclosure. In some embodiments, the external processor may be configured to modify (e.g., transcode) the format of one or more media files (e.g., .PNG to .JPG image format, .MOV to .MP4 video format, etc.). In other embodiments, the external processor may be configured to modify the resolution of one or more media files (e.g., 1080 p video to 720 p video). In such embodiments, the external processor may be further configured to adjust the resolution of one or more media files based, at least in part, on a user selected screen size of the enclosure (e.g., 4 inch screen, 6 inch screen, 12 inch screen, etc.). In additional embodiments, the external processor may be further configured to adjust the orientation of the one or more media files (e.g., portrait to landscape). In other implementations, the external processor is configured to apply one or more digital effects to one or more media files (e.g., blur or otherwise distort a portion of a media file, add text to a media, add a border around a media file, etc.).

Another aspect of the disclosure includes any of the preceding aspects, and an enclosure including a Near-Field Communication (NFC) tag disposed within a portion of the enclosure. The NFC tag including data stored thereon such as, e.g., a unique identifier and/or a Uniform Resource Locator (URL). In such embodiments, the NFC tag enables the user to scan the enclosure with an external device (e.g., mobile phone, tablet, etc.) to access digital content, customized content, promotional offers, or any other digital information provided via the URL. The NFC tag may be configured to pass a unique identifier to the URL (e.g., via an HTTP request), thereby allowing strategic redirection to various landing pages based at least in part on the unique identifier. In some embodiments, a web server hosting the URL may be configured to analyze, identify, track, etc., web traffic associated with the unique identifier and/or URL.

Another aspect of the disclosure includes any of the preceding aspects, and an enclosure including one or more optical sensors disposed within the base and electrically coupled to the controller. Each optical sensor may include, inter alia, one or more of the following: a photoresistor, a photodiode, a phototransistor. Each optical sensor may positioned adjacent to at least one of a set of storage cavities in the base of the enclosure, such that an item disposed in a respective storage cavity blocks the optical sensor from exposure to light, and the optical sensor is then exposed to light when the item is removed from the respective storage cavity. Each optical sensor may be configured to send an electrical signal to the controller indicating when an item has been removed from a respective storage cavity.

Another aspect of the disclosure includes any of the preceding aspects, and an enclosure including one or more pressure sensors (e.g., a strain gauge) disposed within the base and electrically coupled to the controller. Each pressure sensor being configured to determine the presence or absence of a respective item in a respective storage cavity. Each pressure sensor being further configured to transmit an electrical signal to the controller indicating that an item is disposed within, or removed from, a respective storage cavity.

Another aspect of the disclosure includes any of the preceding aspects, and an enclosure including a Radio-Frequency Identification (RFID) tag configured to receive, store, and/or transmit data. The RFID tag may be configured to receive, store, and/or transmit data that includes: a layout of the enclosure; a quantity and/or type of item stored within the enclosure; or any other information relating to the enclosure, items contained within the enclosure, or user provided information (e.g., personalized message).

Another aspect of the disclosure includes any of the preceding aspects, and an enclosure including one or more LEDs disposed on a surface of the enclosure. In some embodiments, the one or more LEDS are configured to emit light in one or more patterns according to a set of program instructions stored on memory of the enclosure. For example, the one or more LEDs may be configured to blink for a period in response to opening the enclosure.

Another aspect of the disclosure includes any of the preceding aspects, and an enclosure including a camera disposed on a surface of the enclosure and electrically coupled to the controller. The controller may be configured to activate the camera in response to one or more user-driven events (e.g., opening enclosure) and/or in response to receiving electrical signals from one or more sensors disposed within the enclosure (e.g., a motion sensor sending electrical signal to the controller). In some embodiments, the camera may be configured to capture image or video of a user in response to opening the enclosure. In such embodiments, the enclosure may be configured to save a captured image or video to a memory electrically coupled to the camera. In other embodiments, the enclosure may be configured to transmit a captured image or video to a remote memory device using a wireless transmission method, e.g., Wi-Fi, Bluetooth, RF, etc.

Another aspect of the disclosure includes any of the preceding aspects, and an enclosure including a processor configured to create a queue of media files. In some embodiments, the queue of media files is created based on the order in which items contained within the enclosure are removed, such that a media file associated with the respective item is added to the queue of media files to display when the item is removed.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

Many advantages of the present invention will be apparent to those skilled in the art with a reading of this specification in conjunction with the attached drawings, wherein like reference numerals are applied to like elements and wherein:

FIG. 1 is an exploded perspective view of an enclosure according to the disclosure.

FIG. 2 is a front view of an enclosure according to the disclosure.

FIG. 3 is a perspective view of an enclosure according to the disclosure.

FIG. 4 is a flow diagram illustrating processes in various methods according to the disclosure.

FIG. 5 is a flow diagram illustrating additional processes in various methods according to the disclosure.

FIG. 6 is a flow diagram illustrating additional processes in various methods according to the disclosure

FIG. 7 is a flow diagram illustrating further processes in various methods according to the disclosure

FIG. 8 is a flow diagram illustrating additional processes in various methods according to the disclosure.

FIG. 9 is a flow diagram illustrating further processes in various methods according to the disclosure.

FIG. 10 is a flow diagram illustrating additional processes in various methods according to the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

Illustrative embodiments of the invention are described below. In the interest of clarity, not all features of an actual implementation are described in this specification. It will of course be appreciated that in the development of any such actual embodiment, numerous implementation- specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

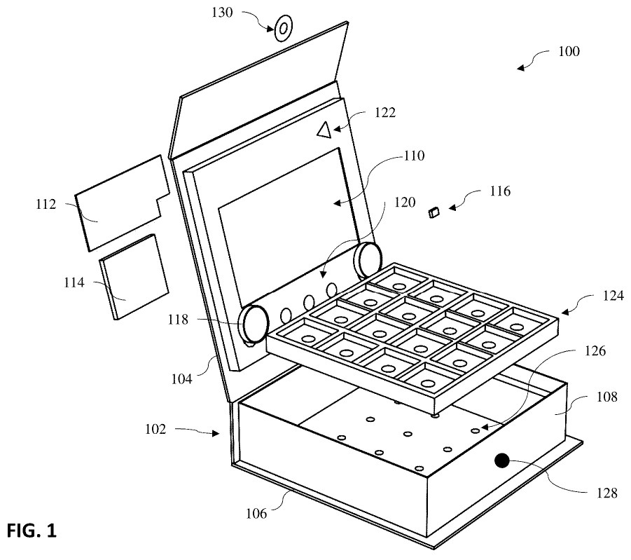

FIG. 1 illustrates an exploded perspective view of an enclosure 100 according to an embodiment of the present disclosure. The enclosure 100 includes a base 102 having a set of storage cavities 124 disposed therein, and a moveable lid 104 coupled with the base 102 for enclosing the set of storage cavities 124. The enclosure 100 can include a rectangular shape including a bottom surface 106, and one or more sidewalls 108 extending between the lid 104 and bottom surface 106. However other geometric configurations for enclosure 100 are within the scope of this disclosure, such as, e.g., spherical, elliptic, triangular, etc. As further shown in FIG. 1, the enclosure 100 further includes a display screen 110 disposed on an inner surface of the moveable lid 104. Display screen 110 is electrically coupled to a memory that is configured to store one or more media files thereon (e.g., image, video, text, audio files, etc.). Display screen 110 is also electrically coupled to a controller 112 configured to display the one or more media files on the display screen 110. The enclosure 100 further includes a power source 114 (e.g., battery, charging capacitor, etc.) that is electrically coupled to the display screen 110, controller 112, and/or memory. A port 116 (e.g., data input port such as a USB or physical connector such as an A/C power connector) is configured to receive an input to charge the power source 114 and/or transmit data (e.g., one or more media files) to/from the memory. In other embodiments, a wireless component is configured to transmit electricity and/or data to the enclosure 100. In some embodiments, the wireless component is integrated with controller 112, such that the controller 112 is configured to receive data from an external source and/or transmit data to the external source.

Enclosure 100 can further include one or more speakers 118 coupled with the controller 112 that are configured to play audio from the one or more media files; and an interface 120 coupled with the controller 112 that is configured to control the display of the one or more media files. The interface 120 may include, among other things, one or more of a play button, a pause button, a skip forward button, a skip backward button, or a volume control button. The interface 120 may include one or more physical buttons, a touch screen interface, haptic feedback, or a combination thereof, to transmit electrical signals to the controller 112 to display, modify, or otherwise control the output on display screen 110.

As further shown in FIG. 1, the enclosure 100 further includes an NFC tag 122 disposed in the moveable lid 104. The NFC tag 122 can include data stored thereon such as, e.g., a unique identifier and/or URL. The NFC tag 122 enables a user to scan the enclosure 100 with an external device (e.g., a smart device such as a smart phone, tablet, etc., not shown) to access digital content, customized content, promotional offers, or any other digital information provided via a URL stored on NFC tag 122. The NFC tag 122 may be configured to pass a unique identifier to the URL (e.g., via an HTTP request), thereby allowing strategic redirection to various landing pages based at least in part on the unique identifier. A web server (not shown) hosting the URL may be configured to analyze, identify, track, etc., web traffic associated with the unique identifier and/or URL.

As further shown in FIG. 1, the set of storage cavities 124 are defined by an insert configured to receive one or more items therein (e.g., chocolates). The enclosure 100 may further include a set of sensors 126 corresponding with the set of storage cavities 124 and coupled with the controller 112. Each sensor 126 can be configured to transmit an electrical signal to the controller 112 to display at least one of the media files on display screen 110. Each sensor 126 can include at least one of an optical sensor (e.g., infrared sensor, photodetector, etc.), a pressure sensor, an electromagnetic sensor, or a motion sensor. In the present embodiment, the set of sensors 126 are disposed in the bottom surface 106 of the base 102 and arranged to determine the presence or absence of an item in a corresponding cavity of the set of cavities 124. Each sensor 126 may be configured to transmit an electrical signal to the controller 112 in response to detecting removal of an item from the corresponding cavity 124, thereby enabling the controller 112 to identify which item(s) are selected from the cavities 124, and play one or more media files accordingly. For example, select media files can be correlated with select cavities 124 in the enclosure 100, enabling select media files (or segments thereof) to be played back in response to detecting removal of one or more items from a select, corresponding cavity 124.

As further shown in FIG. 1, the enclosure 100 may include a lid sensor 130 coupled with the controller 112 for signaling that the movable lid 104 is at least one of opened or closed. The lid sensor can include any sensor type described herein, e.g., similar to sensors 126, and can be configured to detect opening/closing of the lid 104 relative to the base 102. In various implementations, the lid sensor 130 includes a proximity sensor. In one example, the sensor 130 includes a system having a first magnet 128 coupled with the base 102, and a magnetic sensor 130 coupled with the moveable lid 104 and controller 112. The magnetic sensor 130 is configured to transmit an electrical signal to the controller 112 when the magnetic sensor 130 is not in proximity to the first magnet 128. The controller 112 may be configured to play one or more media files on the display screen 110 upon receiving an electrical signal from the magnetic sensor 130 indicating that the moveable lid 104 is opened.

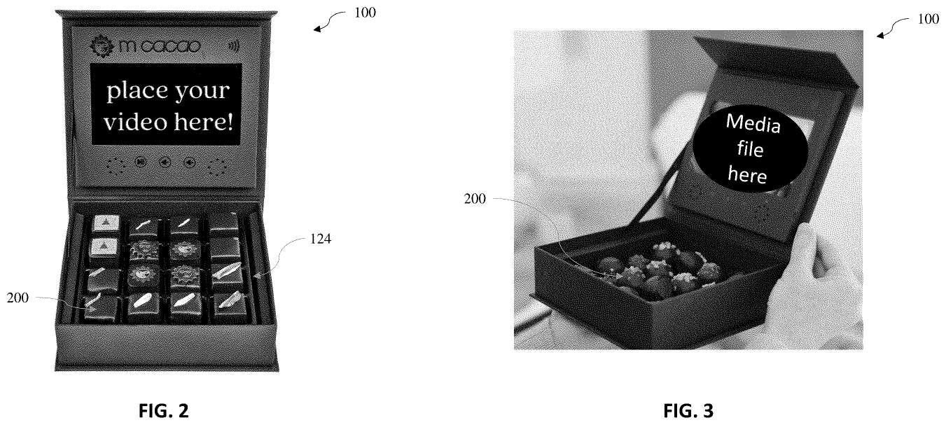

FIG. 2 illustrates a front view of the enclosure 100 of FIG. 1 in an opened position, including items 200 (e.g., confectionaries) in one or more cavities 124. FIG. 3 illustrates a perspective view of the enclosure 100 of FIG. 1 in an opened position, including items 200 in disposed therein.

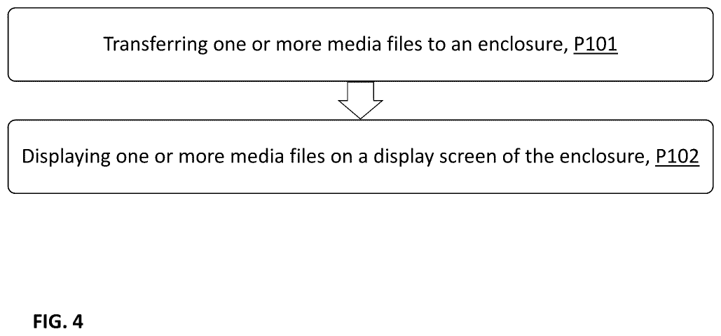

FIGS. 4-8 are flow diagrams illustrating processes in methods according to various aspects of the disclosure. Each flow diagram including multiple process steps (Px) related to the enclosure 100 (FIG. 1) as discussed herein.

FIG. 4 illustrates a method including: (P101) transferring one or more media files to an enclosure 100, e.g., via a hard-wired upload using the port 116 and/or via a wireless upload such as via WiFi and/or Bluetooth to a wireless component connected to or otherwise integrated with a controller 112; and (P102) displaying the one or more media files on a display screen 110 of the enclosure 100.

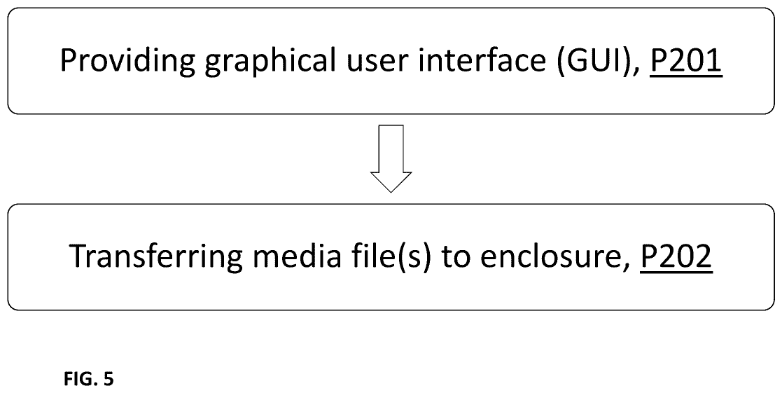

FIG. 5 illustrates a method including: (P201) providing a graphical user interface (GUI) at a device such as a smart device; and (P202) receiving one or more media files via the GUI.

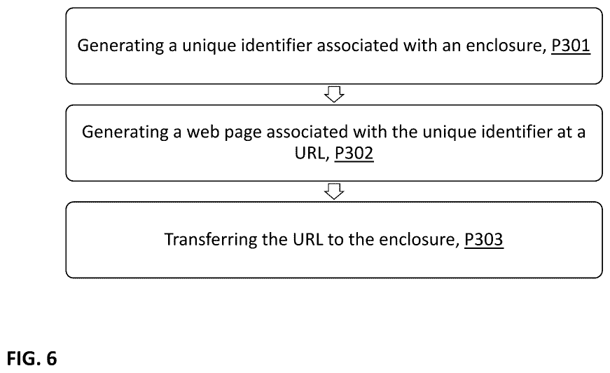

FIG. 6 illustrates a method including: (P301) generating a unique identifier associated with an enclosure 100; (P302) generating a web page associated with the unique identifier at a URL, e.g., to provide custom content to a recipient of the enclosure 100 having the unique identifier; and (P303) transferring the URL to the enclosure 100, e.g., via an NFC tag 122 to enable a recipient of the enclosure 100 to access custom content at the URL.

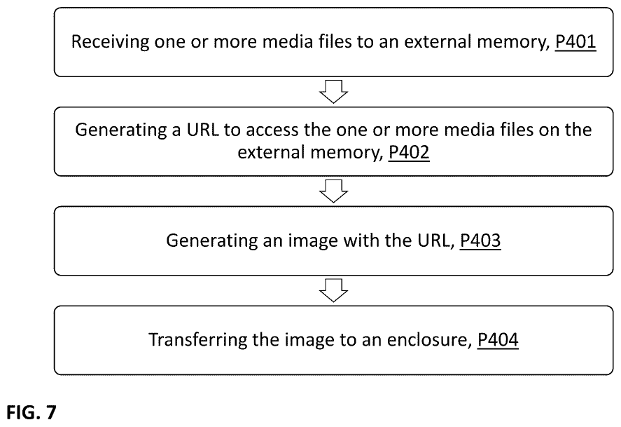

FIG. 7 illustrates a method including: (P401) receiving one or more media files to an external memory (e.g., server); (P402) generating a URL to access the one or more media files on the external memory; (P403) generating an image with the URL; and (P404) transferring the image to an enclosure 100, e.g., via a hard-wired upload and/or via a wireless upload to enable a recipient to access the one or more media files on the external memory via a display screen 110 of the enclosure 100. In some embodiments, the image of the URL includes a QR code that is scannable by an external device (e.g., smart device) to direct the external device to the one or more media files on the external memory. In other embodiments, the image of the URL is an HTTP link that a user can manually enter to direct the external device to the one or more media files on the external memory.

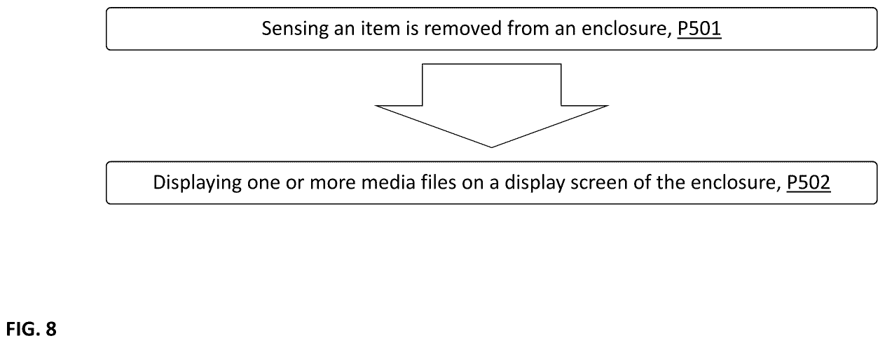

FIG. 8 illustrates a method including: (P501) sensing an item 200 is removed from an enclosure 100, e.g., via one or more sensors 126; and (P502) displaying one or more media files on a display screen 110 of the enclosure 100, e.g., in response to sensing the item 200 is removed.

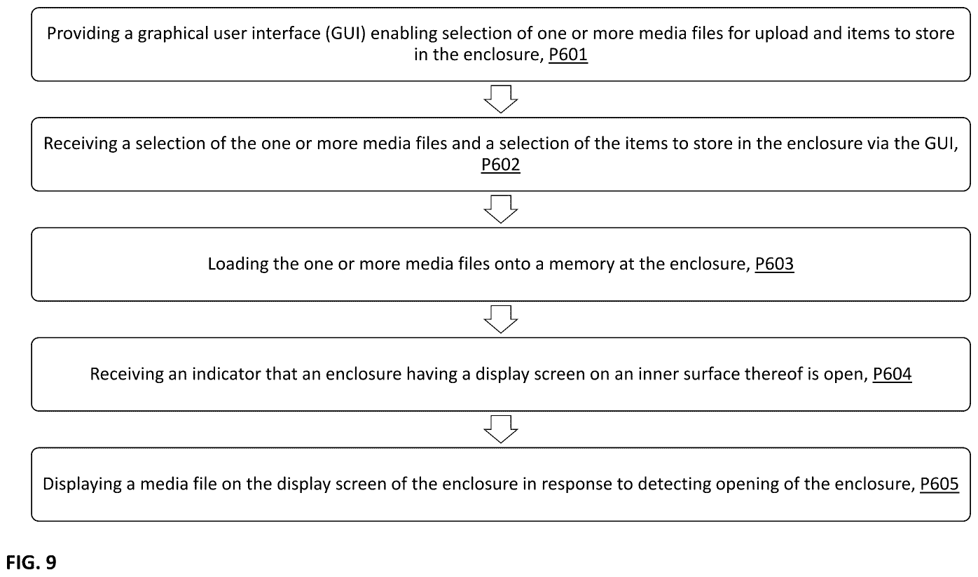

FIG. 9 illustrates a method including: (P601) providing a GUI enabling selection of one or more media files for upload and items to store in the enclosure; (P602) receiving a selection of the one or more media files and a selection of the items to store in the enclosure via the GUI; (P603) loading the one or more media files onto a memory at the enclosure; (P604) receiving an indicator that an enclosure having a display screen on an inner surface thereof is open; and (P605) displaying a media file on the display screen of the enclosure in response to detecting opening of the enclosure.

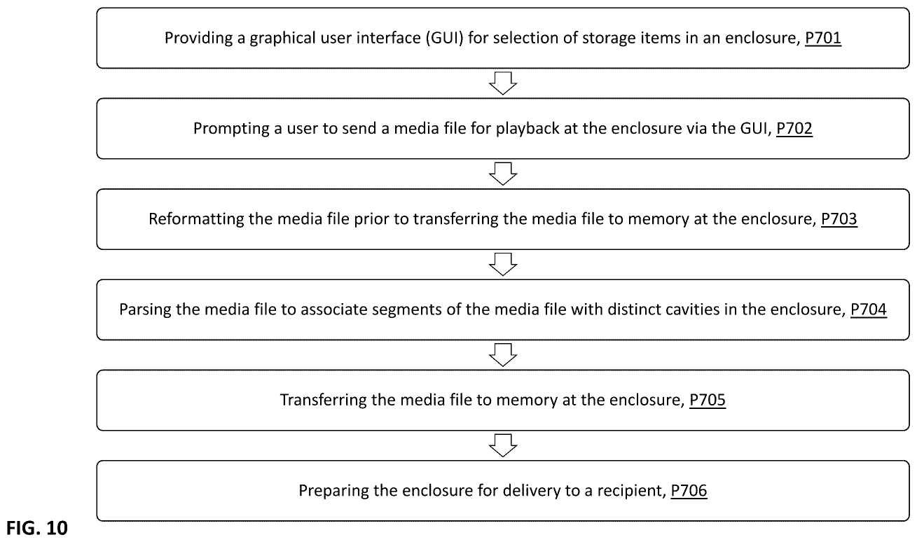

FIG. 10 illustrates a method including: (P701) providing a graphical user interface (GUI) for selection of storage items in an enclosure; (P702) prompting a user to send a media file for playback at the enclosure via the GUI; (P703) reformatting the media file prior to transferring the media file to memory at the enclosure; (P704) parsing the media file to associate segments of the media file with distinct cavities in the enclosure; (P705) transferring the media file to memory at the enclosure; and (P706) preparing the enclosure for delivery to a recipient.

Reformatting the media file in P703 may include transcoding, compressing, or otherwise modifying the media file received from the user via the GUI. Reformatting the media file in P03 may include modifying the media file according to a set of program instructions configured to execute to transcode, compress, or otherwise modify the media file according to any possible methods. In some embodiments, reformatting the media file includes transcoding the media file, which is a direct digital-to-digital conversion of one encoding to another, such as for video files (e.g., MOV, MP4), audio files (e.g., MP3, WAV), or character encoding (e.g., UTF-8). In other embodiments, reformatting the media file includes compressing the media file, which reduces the size of the media file. In other embodiments, reformatting the media file includes modifying the media file with a visual modifier (e.g., blurring, brightening, etc.), an audio modifier (e.g., voice changer), and/or a text overlay superimposed over the media file. In other embodiments, the user provides at least two media files in P702, and reformatting the media files in P703 includes combining at least two media files provided by the user into one media file for transferring to an enclosure according to the disclosure.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer- readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

What is claimed is:

1. An enclosure comprising:
a base including a set of storage cavities;
a moveable lid coupled with the base for enclosing the set of storage cavities;
a memory configured to store at least one media file;
a display screen electrically coupled with the memory and disposed on an inner surface of the moveable lid; and
a controller coupled to the display screen, the controller configured to control display of the at least one media file on the display screen.

2. The enclosure of claim 1, further comprising a set of sensors each corresponding with the set of storage cavities and coupled with the controller, wherein each sensor is configured to transmit an electrical signal to the controller to display at least one of the media files, wherein each sensor comprises at least one of an infrared sensor, a pressure sensor, an electromagnetic sensor, or a motion sensor.

3. The enclosure of claim 1, wherein the set of storage cavities are defined by an insert configured to receive one or more items therein, wherein the one or more items comprise at least one of confectionaries, cosmetic items, food items, gift items, wearable items, or symbols.

4. The enclosure of claim 1, further comprising a lid sensor coupled with the controller for signaling that the movable lid is at least one of opened or closed.

5. The enclosure of claim 4, wherein the lid sensor includes a sensor system having:
a first magnet coupled with the base;
a magnetic sensor coupled with the moveable lid and the controller,
wherein the magnetic sensor is configured to transmit an electrical signal to the controller when the magnetic sensor is not in proximity to the first magnet.

6. The enclosure of claim 5, wherein the controller is configured to initiate playback on the display screen in response to receiving the electrical signal from the magnetic sensor.

7. The enclosure of claim 5, further comprising a second magnet coupled with the moveable lid, wherein the second magnet is configured to clasp with the first magnet in the sidewall in a closed position of the enclosure.

8. The enclosure of claim 7, wherein the magnetic sensor is configured to transmit the electric signal in response to magnetic coupling or magnetic decoupling between the first and second magnets.

9. The enclosure of claim 1, further comprising an interface coupled with the controller and configured to control display of the one or more media files.

10. The enclosure of claim 9, wherein the interface comprises one or more of: a play button, a pause button, a skip forward button, a skip backward button, or a volume control button,
wherein the interface comprises at least one of a touch-screen interface or physical hardware buttons.

11. The enclosure of claim 1, further comprising:
a battery coupled with the controller;
an input port for uploading and/or downloading the at least one media file to the memory;
a speaker configured to play an audio file of the one or more media files.

12. The enclosure of claim 11, wherein the set of storage cavities includes a plurality of storage cavities with an associated sensor, wherein the controller is configured to output a distinct portion of the at least one media file based on receiving an input from a distinct sensor in a distinct storage cavity, wherein the at least one media file includes a plurality of distinct media files each associated with one or more of the plurality of storage cavities.

13. The enclosure of claim 12, wherein each of the plurality of storage cavities is configured to store a distinct item, and in response to removal of an item from a storage cavity as detected by an associated sensor, the controller is configured to output a select one of the distinct media files.

14. A system comprising:
an enclosure, comprising:
a base including a set of storage cavities;
a moveable lid coupled with the base for enclosing the set of storage cavities;
a memory configured to store at least one media file;
a display screen electrically coupled with the memory and disposed on an inner surface of the moveable lid; and
a controller coupled to the display screen, the controller configured to control display of the at least one media file on the display screen; and
an external processor configured to:
receive at least one initial media file;
compare a format of the at least one initial media file with a playback requirement of the controller; and
if the format of the at least one initial media file does not comply with the playback requirement of the controller, reformat one or more initial media files to provide the at least one media file in a compliant format.

15. The system of claim 14, wherein the reformatting comprises at least one of compressing the at least one initial media file, transcoding the at least one initial media file, adjusting a resolution and aspect ratio of the at least one initial media file, or distorting a portion of the at least one initial media file.

16. The system of claim 14, wherein the external processor is further configured to transfer the at least one media file in the compliant format to the memory at the enclosure.

17. A method comprising:
providing a graphical user interface (GUI) for selection of storage items in an enclosure;
prompting a user to send a media file or select a media file for playback at the enclosure via the GUI;
transferring the media file to memory at the enclosure;
loading the storage items in the enclosure; and
preparing the enclosure for delivery to a recipient.

18. The method of claim 17, further comprising reformatting the media file prior to transferring the media file to memory at the enclosure.

19. The method of claim 17, further comprising parsing the media file to associate segments of the media file with distinct cavities in the enclosure.

20. The method of claim 17, wherein the enclosure comprises a display and a controller, wherein the controller is configured to:
receive an indicator that an enclosure having a display screen on an inner surface thereof is open; and
display a media file on the display screen of the enclosure in response to detecting opening of the enclosure.
